(19) United States
(12) Patent Application Publication
(10) Pub. No.: US 2026/0121078 A1
(43) Pub. Date: Apr. 30, 2026

(54) MEMBRANE-ELECTRODE-ASSEMBLY WITH TRIMMED PROTON-CONSUMING ELECTRODE

(71) Applicant: GM GLOBAL TECHNOLOGY OPERATIONS LLC, DETROIT, MI (US)

(72) Inventors: Yunzhu Zhang, Rochester Hills, MI (US); Wenbin Gu, Sterling Heights, MI (US); Yeh-Hung Lai, Oakland, MI (US); Swaminatha P. Kumaraguru, Rochester Hills, MI (US); Craig S. Gittleman, West Bloomfield, MI (US); Thomas D. Bronchetti, Auburn Hills, MI (US)

(21) Appl. No.: 18/928,697

(22) Filed: Oct. 28, 2024

(51) Int. Cl. H01M 4/88

(52) U.S. Cl. CPC H01M 4/881; H01M 4/8807; H01M 4/8878; H01M 2250/20

(57) ABSTRACT

Aspects of the disclosure include a membrane-electrode-assembly (MEA) with a trimmed proton-consuming electrode. An exemplary vehicle includes an electric motor, a battery, and a proton exchange membrane electrochemical cell. The electrochemical cell includes a proton-generating electrode, a proton-consuming electrode, and a membrane positioned between the proton-generating electrode and the proton-consuming electrode (the proton-generating electrode, proton-consuming electrode, and membrane collectively defining a membrane-electrode-assembly), and a gas diffusion layer positioned in direct contact with the proton-consuming electrode. The proton-consuming electrode is trimmed with respect to a first edge of the membrane and with respect to a second edge of the membrane. The first edge is orthogonal to the second edge. The proton-consuming electrode is trimmed using laser ablation at a focus depth that bypasses the membrane.

### INTRODUCTION

The present disclosure relates to hydrogen fuel cells and water electrolysis, and particularly to a membrane-electrode-assembly (MEA) with a trimmed proton-consuming electrode using catalyst coated diffusion media with membrane attached (CCDMm) processes.

Hydrogen fuel cells and related technologies have emerged as a promising clean energy solution, offering high efficiency and zero emissions for various applications ranging from transportation (e.g., personal and commercial vehicles, shipping, aircraft, etc.) to stationary power generation. One type of hydrogen electrochemical cell is the proton exchange membrane (PEM) fuel cell (similarly, the PEM water electrolyzer). In a PEM fuel cell, hydrogen enters through an anode, where it's split into protons and electrons. The protons pass through an electrolyte membrane, while electrons flow through an external circuit, generating electricity. At the cathode, protons, electrons, and oxygen combine to produce water. Hydrogen fuel cells are typically implemented in fuel cell stacks—assemblies of multiple individual hydrogen fuel cells connected in series to increase overall voltage and power output.

Hydrogen fuel cells require a supply of hydrogen fuel that can be provided via one or more electrolysis cells. An electrolysis cell is a device that uses electrical energy to drive a non-spontaneous chemical reaction that splits water (H₂O) into hydrogen (H₂) and oxygen (O₂) gases. An electrolysis cell typically includes an anode, a cathode, and an electrolyte. When an electric current is applied between the anode and cathode, water molecules are split at the anode to produce oxygen gas and protons (H⁺), while at the cathode, protons combine with electrons to produce hydrogen gas.

### SUMMARY

In one exemplary embodiment a proton exchange membrane (PEM) electrochemical cell includes a proton-generating electrode, a proton-consuming electrode, a membrane positioned between the proton-generating electrode and the proton-consuming electrode (the proton-generating electrode, proton-consuming electrode, and membrane collectively defining a membrane-electrode-assembly (MEA)), and a gas diffusion layer positioned in direct contact with the proton-consuming electrode. The proton-consuming electrode is trimmed with respect to a first edge of the proton-generating electrode and with respect to a second edge of the proton-generating electrode. The first edge is orthogonal to the second edge. The proton-consuming electrode is trimmed using laser ablation at a focus depth that bypasses the membrane.

In addition to one or more of the features described herein, in some embodiments, the proton consuming cathode electrode is directly applied to the gas diffusion layer.

In some embodiments, the membrane is applied to the proton-consuming electrode via direct coating or lamination.

In some embodiments, the PEM electrochemical cell is an electrolyzer.

In some embodiments, the electrolyzer includes a porous transport layer in direct contact with the proton-generating electrode.

In some embodiments, the electrolyzer includes a gas diffusion layer in direct contact with the proton-consuming electrode.

In some embodiments, the gas diffusion layer is connected via flow channels to an outtake header configured to remove hydrogen gas from the electrolyzer.

In some embodiments, the PEM electrochemical cell is a fuel cell.

In some embodiments, the fuel cell includes a second gas diffusion layer in direct contact with the proton-generating electrode.

In some embodiments, the gas diffusion layer is connected via flow channels to an intake header and an outtake header. The intake header is configured to supply oxygen gas to the fuel cell and the outtake header is configured to remove water and air from the fuel cell.

In another exemplary embodiment a vehicle includes an electric motor, a battery, and a PEM electrochemical cell. The PEM electrochemical cell includes a proton-generating electrode, a proton-consuming electrode, a membrane positioned between the proton-generating electrode and the proton-consuming electrode (the proton-generating electrode, proton-consuming electrode, and membrane collectively defining an MEA), and a gas diffusion layer positioned in direct contact with the proton-consuming electrode. The proton-consuming electrode is trimmed with respect to a first edge of the proton-generating electrode and with respect to a second edge of the proton-generating electrode. The first edge is orthogonal to the second edge. The proton-consuming electrode is trimmed using laser ablation at a focus depth that bypasses the membrane.

In some embodiments, the proton consuming cathode electrode is directly applied to the gas diffusion layer.

In some embodiments, the membrane is applied to the proton-consuming electrode via direct coating or lamination.

In some embodiments, the PEM electrochemical cell is an electrolyzer.

In some embodiments, the electrolyzer includes a porous transport layer in direct contact with the proton-generating electrode.

In some embodiments, the electrolyzer includes a gas diffusion layer in direct contact with the proton-consuming electrode.

In some embodiments, the gas diffusion layer is connected via flow channels to an outtake header configured to remove hydrogen gas from the electrolyzer.

In some embodiments, the PEM electrochemical cell is a fuel cell.

In some embodiments, the fuel cell includes a second gas diffusion layer in direct contact with the proton-generating electrode.

In some embodiments, the gas diffusion layer is connected via flow channels to an intake header and an outtake header. The intake header is configured to supply oxygen gas to the fuel cell and the outtake header is configured to remove water and air from the fuel cell.

In yet another exemplary embodiment a method can include forming a PEM electrochemical cell. The method includes forming a proton-generating electrode, forming a proton-consuming electrode, forming a membrane positioned between the proton-generating electrode and the proton-consuming electrode (the proton-generating electrode, proton-consuming electrode, and membrane collectively defining an MEA), and forming a gas diffusion layer positioned in direct contact with the proton-consuming electrode. The method further includes trimming the proton-consuming electrode with respect to a first edge of the proton-generating electrode and with respect to a second edge of the proton-generating electrode. The first edge is orthogonal to the second edge. The proton-consuming electrode is trimmed using laser ablation at a focus depth that bypasses the membrane.

In some embodiments, the proton consuming cathode electrode is directly applied to the gas diffusion layer.

In some embodiments, the membrane is applied to the proton-consuming electrode via direct coating or lamination.

In some embodiments, the PEM electrochemical cell is an electrolyzer.

In some embodiments, the method includes forming a porous transport layer in direct contact with the proton-generating electrode.

In some embodiments, the gas diffusion layer is connected via flow channels to an outtake header configured to remove hydrogen gas from the electrolyzer.

In some embodiments, the PEM electrochemical cell is a fuel cell.

In some embodiments, the method includes forming a second gas diffusion layer in direct contact with the proton-generating electrode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2A depicts an electrolyzer in accordance with one or more embodiments;

FIG. 2B depicts a fuel cell in accordance with one or more embodiments;

FIGS. 3A-3D depict successive stages of a laser ablation technique for forming a catalyst coated diffusion media with membrane attached (CCDMm) with a trimmed proton-consuming electrode in accordance with one or more embodiments;

FIG. 4A depicts an alternative laser ablation technique to that shown with respect to FIG. 3D in accordance with one or more embodiments;

FIG. 4B depicts a plan view of the CCDMm shown in FIG. 4A in accordance with one or more embodiments;

FIG. 5. is a computer system according to one or more embodiments;

FIG. 6 is a flowchart in accordance with one or more embodiments;

FIG. 7A is a plan view of a proton exchange membrane (PEM) electrochemical cell in accordance with one or more embodiments; and

FIG. 7B is a cross-sectional view of the PEM electrochemical cell of

FIG. 7A taken at line A-A in accordance with one or more embodiments.

### DETAILED DESCRIPTION

The following description is merely exemplary in nature and is not intended to limit the present disclosure, its application or uses.

Understanding and optimizing proton exchange membrane (PEM) type electrochemical cells, such as hydrogen fuel cells and electrolysis cells (also referred to as electrolyzers), has become crucial for widespread adoption and commercialization of hydrogen fuel cell technologies. One of the key components in PEM type electrochemistry cells is the membrane electrode assembly (MEA). In a PEM cell, the MEA serves as the core functional unit where the primary electrochemical reactions occur, converting chemical energy into electrical energy (in fuel cells) or electrical energy into chemical energy (in electrolysis cells). More specifically, in a PEM fuel cell, the MEA facilitates the oxidation of hydrogen at the anode and the reduction of oxygen at the cathode, generating electricity along with byproduct water, while in a PEM electrolysis cell, the MEA facilitates the splitting of water into hydrogen and oxygen gases by use of electricity.

As research into hydrogen fuel cell technology advances, optimizing MEA design will continue to be a critical driver in improving overall performance and durability. Unfortunately, in PEM cells a significant challenge arises from the migration of cations, such as those dissolved from catalysts or membrane degradation mitigants, toward the edges of the membrane electrode assembly (MEA). This migration occurs due to a steep potential drop in regions where the proton-consuming electrode layer extends beyond the proton-producing electrode layer. The resulting cation migration can lead to the degradation of catalysts (e.g., platinum, iridium, etc.) or the depletion of mitigants (e.g. Ce³⁺ or Mn²⁺) in the active area near these regions, thereby reducing the efficiency and durability of PEM electrochemical cells.

Existing solutions to address cation migration in PEM electrochemical cells often involve careful alignment of the proton-producing and proton-consuming electrode layers. However, these methods face limitations, particularly in conventional MEA architectures such as catalyst-coated membranes. Achieving precise alignment becomes increasingly challenging when using at-scale multi-layer processes that rely on membrane lamination or direct membrane coating on an electrode, as these methods introduce additional layers and processing steps which hinder the ability to precisely control the overlap between the proton-producing and proton-consuming electrodes, leading to potential inefficiencies and reduced cell performance.

This disclosure introduces a novel MEA assembly and manufacturing approach that addresses the issue of cation migration in PEM electrochemical cells—specifically, an MEA assembly is provided that has a trimmed proton-consuming electrode. Rather than relying upon alignment controls between the proton-producing and proton-consuming electrode layers, a femtosecond laser ablation technique is leveraged to precisely trim the proton-consuming electrode layer at the edges of the MEA. This process ensures that the proton-producing electrode extends beyond the proton-consuming electrode layer, thereby controlling the potential gradient at the MEA edges and preventing cation migration away from active area (or cation accumulation in the inactive edges). The femtosecond laser ablation method described herein allows for accurate and targeted removal of the electrode layer without damaging the membrane layer, enhancing the performance and lifespan of PEM electrochemical cells. Advantageously, the MEA assembly and manufacturing approaches described herein are compatible with both membrane lamination and direct membrane coating processes.

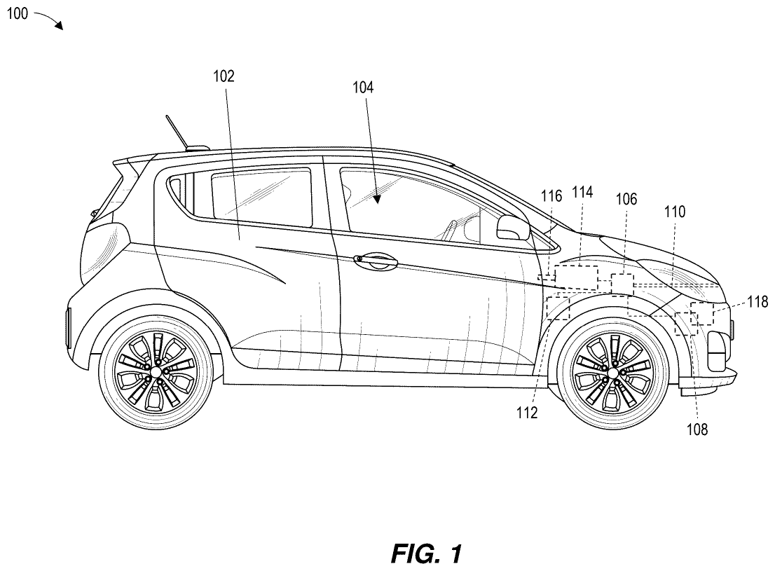

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, a fuel cell 106 (also referred to as a “fuel cell stack”), a hydrogen fuel storage tank 108, an air intake manifold 110, a battery 112, and an electric motor 114 configured for utilizing electrical energy to provide an output torque to an output component 116 (each shown by projection near the front hood). Fuel cell 106 receives a flow of hydrogen or other fuel gas from the hydrogen fuel storage tank 108 and receives a flow of air including oxygen gas from air intake manifold 110. The fuel cell 106 may include an air compressor device (not separately indicated) useful to pressurize the air to a desired pressure. The fuel cell 106 may provide electrical energy directly to the electric motor 114 and/or the fuel cell 106 may provide electrical energy to the battery 112 for storage and later use. The output component 116 may provide the output torque for usage, for example, to provide a motive force to the vehicle 100. In some embodiments, vehicle 100 includes an electrolyzer 118 (electrolysis cells) configured to produce and deliver hydrogen to the hydrogen fuel storage tank 108 and/or fuel cell 106.

The fuel cell 106, hydrogen fuel storage tank 108, air intake manifold 110, battery 112, electric motor 114, and electrolyzer 118 are shown for ease of illustration and discussion only. It should be understood that the configuration, location, size, arrangement, etc., of these components is not meant to be particularly limited, and all such configurations (including multi-motor configurations) are within the contemplated scope of this disclosure. Moreover, while the present disclosure is discussed primarily in the context of a fuel cell 106 and electrolyzer 118 configured for the vehicle 100, aspects described herein can be similarly incorporated within any system (vehicle, building, or otherwise) having a hydrogen fuel cell-based power and/or energy storage system(s), and all such configurations and applications are within the contemplated scope of this disclosure. In particular, the electrolyzer 118 need not be incorporated within vehicle 100 at all, and, in some embodiments, is instead configured as an entirely separate unit for standalone hydrogen production (perhaps for serving vehicle 100 and other downstream applications).

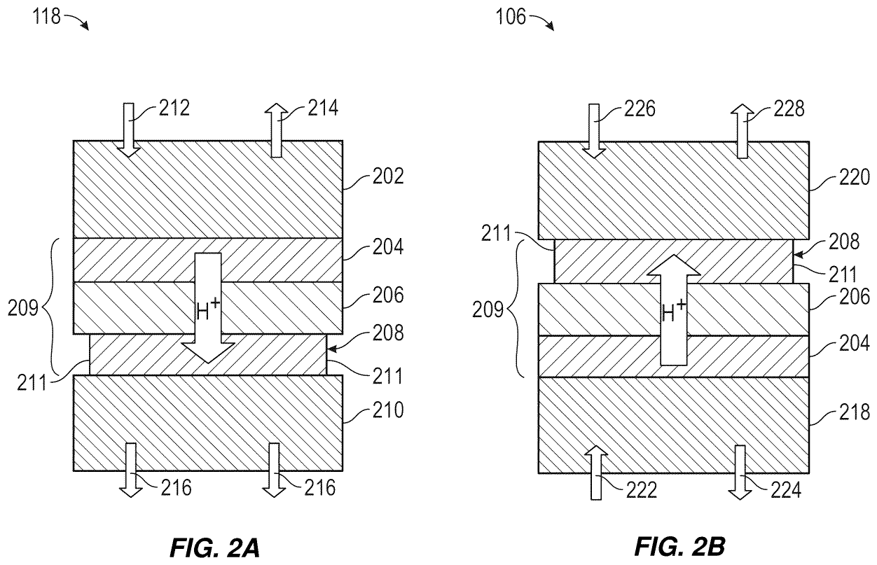

FIG. 2A depicts an electrolyzer 118 in accordance with one or more embodiments. As shown in FIG. 2A, electrolyzer 118 includes a porous transport layer (PTL) 202, a proton-generating electrode 204 (also referred to as an anode or as an H⁺ generating electrode), membrane 206, a proton-consuming electrode 208 (also referred to as a cathode or as an H⁺ consuming electrode), and a gas diffusion layer (GDL) 210 (sometimes referred to as a diffusion media, or DM), configured and arranged as shown. In an electrolyzer type configuration, protons (H⁺) are generated in the proton-generating electrode 204 and are passed through the membrane 206 to the proton-consuming electrode 208. In some embodiments, the proton-generating electrode 204 (the anode) and proton-consuming electrode 208 (the cathode) are coupled to a power source (not separately indicated) which supplies a current across the anode and cathode so that water fed to the electrolyzer 118 can be split into hydrogen and oxygen. The combination of proton-generating electrode 204, membrane 206, and proton-consuming electrode 208 together define a membrane electrode assembly (MEA) 209.

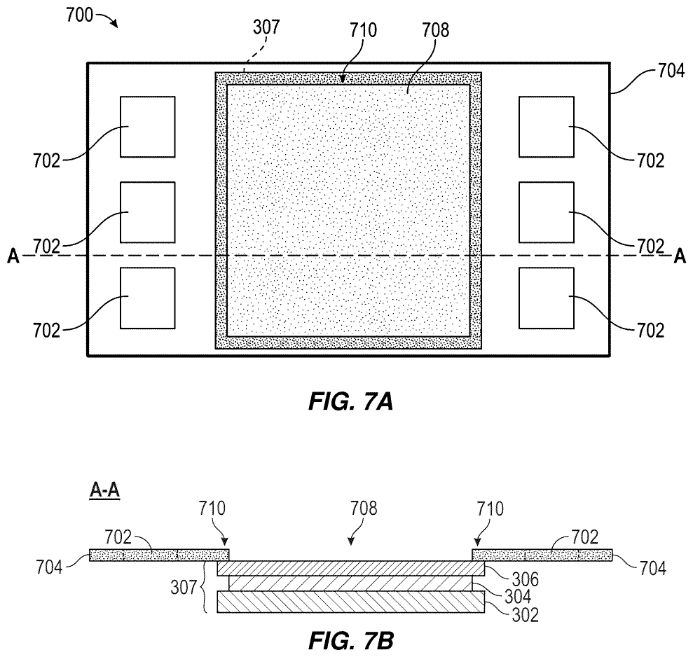

In some embodiments, PTL 202 facilitates a uniform distribution of reactant fluids, typically water, across the proton-generating electrode 204 and to membrane 206. PTL 202 also facilitates the efficient removal of by-products such as oxygen gas from electrolyzer 118. In some embodiments, PTL 202 is made of materials that offer a combination of high electrical conductivity, chemical stability, mechanical strength, and porosity, such as, for example, sintered titanium, stainless steel, and nickel-based materials such as nickel foam. The porous structure of the PTL 202 allows for uniform distribution of water across the active area (refer to FIG. 7) of the MEA 209, enhancing the electrochemical reactions therein. Additionally, the PTL 202 provides electrical conductivity and mechanical support to electrolyzer 118. In some embodiments, PTL 202 is connected via flow channels (not separately indicated) to an intake header 212 and an outtake header 214. In some embodiments, intake header 212 serves as the entry point(s) to the proton-generating electrode layer 208 and membrane 206 for reactant fluid, typically water, which is necessary for the electrochemical reactions occurring within the MEA 209. Conversely, outtake header 214 ensures the efficient evacuation of oxygen and excess water from electrolyzer 118.

In some embodiments, the proton-generating electrode 204 is positioned directly adjacent to the PTL 202 and between PTL 202 and membrane 206 (as shown). The proton-generating electrode 204 is responsible for the oxidation of water molecules during the electrolysis process, producing oxygen gas, protons (H⁺), and electrons. The protons generated at the proton-generating electrode 204 pass through the membrane 206 to the proton-consuming electrode 208, while the electrons flow through an external circuit (not separately shown). The proton-generating electrode 204 is designed to facilitate efficient electrochemical reactions, ensuring optimal hydrogen production and can be coupled with the PTL 202 to ensure uniform distribution of water and the effective removal of oxygen gas.

In some embodiments, MEA 209 is positioned between the PTL 202 and GDL 210. MEA 209 is the core functional unit of the electrolyzer 118 and denotes the active area (e.g., active area 708, refer to FIG. 7) where the primary electrochemical reactions occur, converting electrical energy into chemical energy by splitting water into hydrogen and oxygen gases. The MEA 209 can include several layers, including a proton exchange membrane (PEM, e.g., membrane 206), an anode catalyst layer (e.g., proton-generating electrode 204), and a cathode catalyst layer (e.g., proton-consuming electrode 208). The PEM is a solid polymer electrolyte that conducts protons (H⁺) while acting as an insulator for electrons, ensuring that the protons generated at the anode can pass through to the cathode while preventing the mixing of product gases. The catalyst layers are attached (laminated to or directly coated on) on both sides of the PEM and typically contain finely dispersed catalytic particles, such as platinum (Pt), supported on carbon particles. These catalyst layers facilitate the electrochemical reactions: at the anode, water molecules are oxidized to produce oxygen gas, protons, and electrons, while at the cathode, protons and electrons combine to form hydrogen gas. More specifically, the proton-generating electrode 204 is sandwiched between membrane 206 and PTL 202 and contains finely dispersed catalyst particles such as iridium (Ir) and/or titanium oxide particles. On the other hand, the proton consuming electrode 208 is sandwiched between membrane 206 and GDL 210 and contains finely dispersed catalyst particles such as platinum (Pt), supported by carbon particles. The catalyst layers can be coated on the membrane 206, coated on the PTL 202, coated on the GDL 210, and/or decal transferred to any or all of membrane 206, PTL 202, and GDL 210.

In some embodiments, the proton-consuming electrode 208 is positioned directly adjacent to the membrane 206 and between membrane 206 and GDL 210 (as shown). The proton-consuming electrode 208 is responsible for the reduction of protons (H⁺) and electrons to form hydrogen gas during the electrolysis process. The proton-consuming electrode 208 facilitates the efficient combination of protons, which have passed through the membrane 206 from the proton-generating electrode 204, with electrons that have traveled through an external circuit (e.g., a power source, not separately indicated). The proton-consuming electrode 208 is designed to facilitate efficient electrochemical reactions, ensuring optimal hydrogen evolution and can be coupled with the GDL 210 to ensure a uniform removal of hydrogen gas from the electrolyzer 118.

As further shown in FIG. 2A, the proton-consuming electrode 208 is trimmed with respect to the proton-generating electrode 204 and membrane 206. In some embodiments, edges 211 of the proton-consuming electrode 208 are recessed using a femtosecond laser ablation technique described herein. In this manner, the potential gradient at the membrane 206 near the proton-consuming electrode 208 is controlled, preventing cation migration toward inactive regions and improving electrochemical cell performance and lifespan.

In some embodiments, GDL 210 is a porous material such as carbon fiber paper or cloth, that facilitates a uniform evacuation of hydrogen gas from MEA 209. In some embodiments, GDL 210 is connected via flow channels (not separately indicated) to one or more outtake header(s) 216. In some embodiments, outtake headers 216 serves as the exit point(s) to the proton-consuming electrode layer 208 and membrane 206 for the byproducts, typically hydrogen gas.

FIG. 2B depicts a fuel cell 106 in accordance with one or more embodiments. Fuel cell 106 is configured similarly to the electrolyzer 118 discussed with respect to FIG. 2A, except that, in a fuel cell type configuration, the proton-generating electrode 204 and proton-consuming electrode 208 are coupled to a load (e.g., an electric motor, etc., not separately indicated) which is powered via a current generated by the fuel cell 106. Current is generated within fuel cell 106 due to the reaction of hydrogen gas with oxygen, producing water. Specifically, hydrogen is oxidized at the proton-generating electrode 204, conducting electrons through an external circuit (not separately indicated), typically coupled to a load, and conducting protons through the membrane 206. During this process oxygen is reduced at the proton-consuming electrode 208 to form water.

As shown in FIG. 2B, fuel cell 106 includes a proton-generating electrode 204, a proton-consuming electrode 208, and membrane 206 between proton-generating electrode 204 and proton-consuming electrode 208. The combination of proton-generating electrode 204, membrane 206, and proton-consuming electrode 208 together defines an MEA 209. In a fuel cell type configuration, these components work together to convert chemical energy from hydrogen and oxygen into electrical energy through electrochemical reactions, as opposed to the electrolyzer configuration in FIG. 2A, which uses electrical energy to split water into hydrogen and oxygen. In the fuel cell configuration, the proton-generating electrode 204 is where hydrogen gas (H₂) is supplied and oxidized. The protons generated at the proton-generating electrode 204 pass through the membrane 206 to the proton-consuming electrode 208, while the electrons are conducted away from the anode through an external circuit (not separately shown), creating an electric current that can be used to power a load. In this configuration, the proton-consuming electrode 208 is where oxygen gas (O₂) is supplied and reduced. At the proton-consuming electrode 208, the protons (H⁺) that have passed through the PEM combine with the electrons (e⁻) that have traveled through the external circuit and with oxygen molecules to form water (H₂O).

Fuel cell 106 further includes a GDL 218 and a GDL 220. In some embodiments, GDL 218 is connected via flow channels (not separately indicated) to intake headers 222 and outtake headers 224, while GDL 220 is connected via flow channels (not separately indicated) to intake headers 226 and outtake headers 228. In a fuel cell type configuration, intake headers 222 supply fuel, typically hydrogen gas, to the fuel cell 106, while outtake headers 224 remove excess fuel from fuel cell 106. Conversely, intake headers 226 supply oxygen (typically as air) to fuel cell 106, while outtake headers 228 remove water from the fuel cell 106.

As further shown in FIG. 2B, the proton-consuming electrode 208 is trimmed with respect to the proton-generating electrode 204 and membrane 206, in a similar manner as discussed with respect to FIG. 2A. In some embodiments, edges 211 of the proton-consuming electrode 208 are recessed using a femtosecond laser ablation technique refer described herein. In this manner, the potential gradient at the MEA 209 near the proton-consuming electrode 208 is controlled, preventing cation migration toward inactive regions and improving electrochemical cell performance and lifespan.

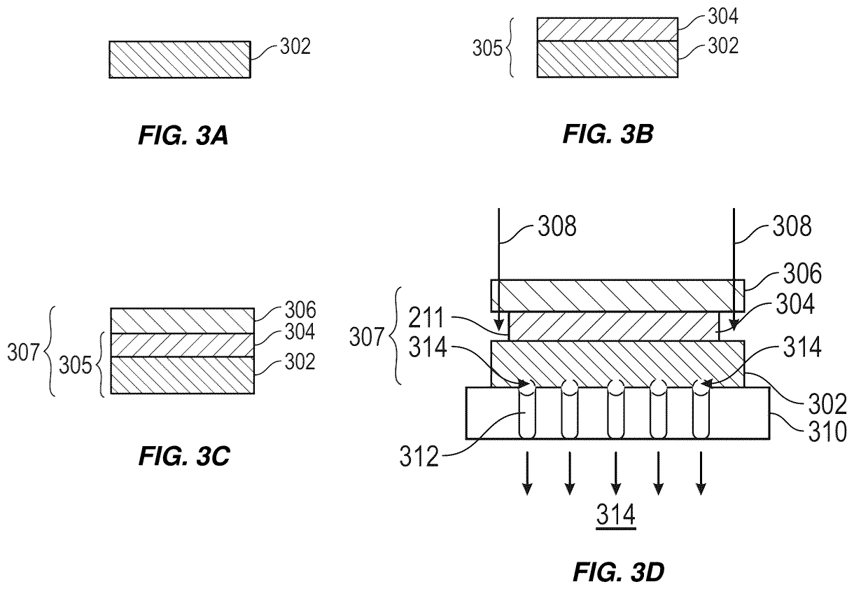

FIGS. 3A-3D depict successive stages of a laser ablation technique for forming a catalyst coated diffusion media with membrane attached (CCDMm) with a trimmed proton-consuming electrode in accordance with one or more embodiments. As shown in FIG. 3A, the laser ablation technique begins with the fabrication or sourcing of a GDL 302 (note that GDL 302 can refer to any GDL or PTL layer of the electrolyzer 118 and/or fuel cell 106 of FIGS. 2A and 2B, depending on the specific application). GDL 302 is not meant to be particularly limited, but can include, for example, a porous material such as carbon fiber paper or cloth. In some embodiments, GDL 302 is a diffusion media (DM) electrode substrate.

In FIG. 3B, a coating electrode 304 (catalyst layer) is formed on the GDL 302, thereby defining a catalyst coated diffusion media (CCDM) 305. In some embodiments, CCDM 305 is an H⁺ consuming electrode (refer to proton-consuming electrode 208 of FIGS. 2A and 2B). While not meant to be particularly limited, catalyst can be applied onto the GDL 302 in the form of a catalyst ink, which is a suspension of finely dispersed catalytic particles (such as platinum, platinum alloys, platinum-iridium alloys, platinum-ruthenium allows, platinum-cobalt alloys, etc.) in a solvent. The catalyst ink can include a binder, such as polyvinylidene fluoride (PVDF), polytetrafluoroethylene (PTFE), polyvinyl alcohol (PVA), polyethylene oxide (PEO), polyacrylic acid (PAA), and/or carboxymethyl cellulose (CMC), which helps catalyst particles adhere to the DM and provides proton conductivity. In some embodiments, catalyst ink can be prepared by mixing the catalyst particles, binder, and solvent to achieve a uniform and stable suspension.

In FIG. 3C, a membrane 306 is laminated to or directly coated over the CCDM 305, thereby defining a CCDM with membrane attached (CCDMm) 307. In some embodiments, the membrane 306 is a PEM (refer to membrane 206 of FIGS. 2A and 2B). While not meant to be particularly limited, CCDMm 307 can include, for example, a proton exchange membrane (PEM) such as those made from perfluorosulfonic acid polymers, although other proton-conducting membranes such as those including polybenzimidazole and sulfonated aromatic polymers are within the contemplated scope of this disclosure.

In FIG. 3D, electrode 304 is trimmed with respect to the GDL 302 and membrane 306. In some embodiments, electrode 304 is trimmed via a laser ablation technique. In some embodiments, electrode 304 is trimmed via exposure to a femtosecond pulse laser. In some embodiments, electrode 304 is trimmed via exposure to a CO₂ laser. In some embodiments, electrode 304 is trimmed via the use of laser pulses. The laser technologies used for trimming are not meant to be particularly limited and can include femtosecond laser, CO₂ lasers, or any other laser technologies which can precisely remove excess catalyst layer material without causing thermal damage to the CCDMm 307 (e.g., to the underlying diffusion media and PEM).

In some embodiments, one or more laser beams 308 are positioned over the CCDMm 307 and a focus of the laser beam(s) 308 is set to a depth corresponding to GDL 302. In this manner, the laser beams 308 can be used to eliminate (trim) portions of the electrode 304 without damaging the membrane 306 and/or GDL 302. In some embodiments, electrode 304 is trimmed to a depth of 100 microns with respect to the membrane 306 and/or GDL 302, although other trim depths, such as from 1 micron to 1000 microns, are within the contemplated scope of this disclosure. In some embodiments, electrode 304 is trimmed to a depth of 100 microns +/− a manufacturing tolerance.

In some embodiments, GDL 302, electrode 304, and membrane 306 are placed over a vacuum plate 310 having ports 312 during the laser ablation process. In some embodiments, a vacuum 314 is applied to the ports 312 during the laser ablation process. Applying a vacuum to the GDL 302, electrode 304, and membrane 306 during the laser ablation process ensures that catalyst ablation (e.g., platinum) does not redeposit onto any layers of the assembly (e.g., to ensure platinum ablation does not lead to redeposition onto any MPL, carbon fibers, or carbon paper substrates). In some embodiments, ports 312 are positioned to direct vacuum 314 to pull gases inwards away from edges of the electrode 304, further mitigating the risks of redeposition.

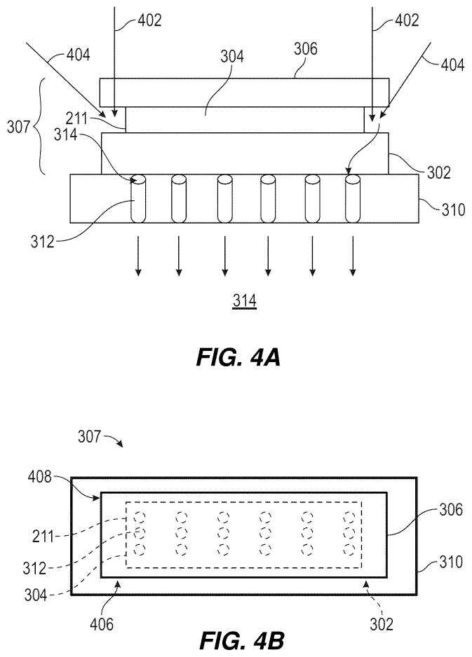

FIG. 4A depicts an alternative laser ablation technique to that shown with respect to FIG. 3D in accordance with one or more embodiments. In contrast to the laser beams 308, the laser ablation technique of FIG. 4A includes two sets of lasers: first lasers 402 and second lasers 404. In this configuration, the first lasers 402 and second lasers 404 are applied at different angles with respect to the electrode 304. For example, in some embodiments, first lasers 402 are applied at an angle substantially orthogonal (e.g., 90 degrees) to the electrode 304, while second lasers 404 are applied at an angle between 5 and 80 degrees, for example 45 degrees, to the electrode 304. In some embodiments, first lasers 402 and second lasers 404 are configured such that the respective beams intersect at a sublayer portion (not separately indicated) of the electrode 304 of interest (e.g., the portion(s) to be trimmed).

FIG. 4B depicts a top-down view of the CCDMm 307 and vacuum plate 310 shown in FIG. 4A in accordance with one or more embodiments. As shown in FIG. 4B, electrode 304 is trimmed (recessed) from both a first edge 406 of the membrane 306 (e.g., a horizontal edge) and a second edge 408 of the membrane 306 (e.g., a vertical edge). In some embodiments, electrode 304 is trimmed (recessed) with respect to either, or both, of the first edge 406 and the second edge 408, as desired.

While the laser ablation techniques described herein are discussed primarily with respect to 3-layer MEA configurations obtained by CCDM and CCDMm processes described herein, other applications are possible. For example, alternatively, a stand-alone membrane in a roll form can be laminated on to a CCDM to form a three-layer configuration and the CCDM of such a system can be trimmed via laser ablation in a similar manner as described with respect to FIG. 3D and/or FIG. 4A. In still other embodiments, an unrolled membrane coated gas diffusion electrode (GDE) assembly and/or patch membrane GDE assembly (not separately indicated) can be similarly trimmed using laser ablation techniques described herein. In some embodiments, a laser can be used to ablate a layer of less than 15-micron thickness, trimming a target electrode layer (e.g., a proton-consuming electrode layer) without damaging the membrane layer near the respective edges.

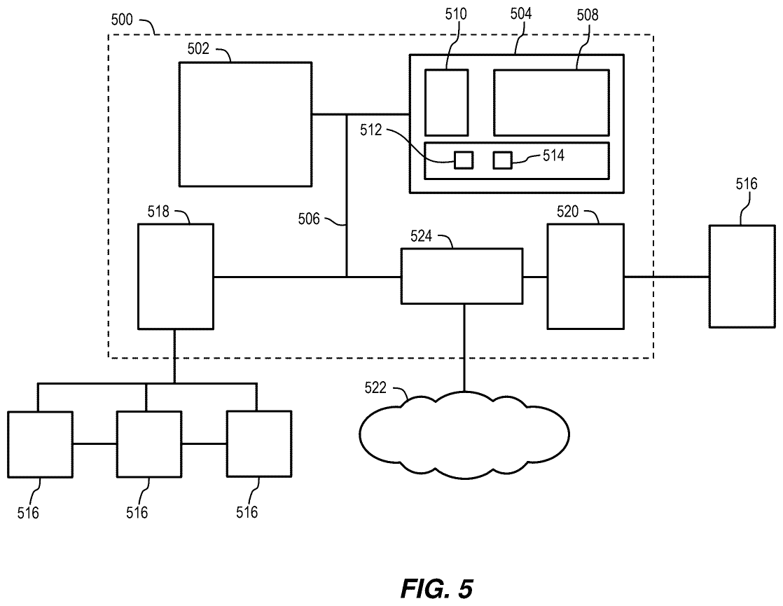

FIG. 5 illustrates aspects of an embodiment of a computer system 500 that can perform various aspects of embodiments described herein. In some embodiments, the computer system(s) 500 can fabricate, implement, and/or otherwise be incorporated within or in combination with a fuel cell and/or electrolyzer system, such as fuel cell 106 and/or electrolyzer 118 (refer to FIG. 1). For example, in some embodiments, computer system 500 can control a laser to manage a laser ablation technique described herein for trimming proton-consuming electrode layers.

The computer system 500 includes at least one processing device 502, which generally includes one or more processors or processing units for performing a variety of functions, such as, for example, any and/or all of the functions described previously herein. Components of the computer system 500 also include a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media. For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to any of the block diagrams described herein. The computer system 500 is not so limited, as other modules may be included depending on the desired functionality of the computer system 500. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 502 can also be configured to communicate with one or more external devices 516 such as, for example, a keyboard, a pointing device, and/or any devices (e.g., a network card, a modem, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

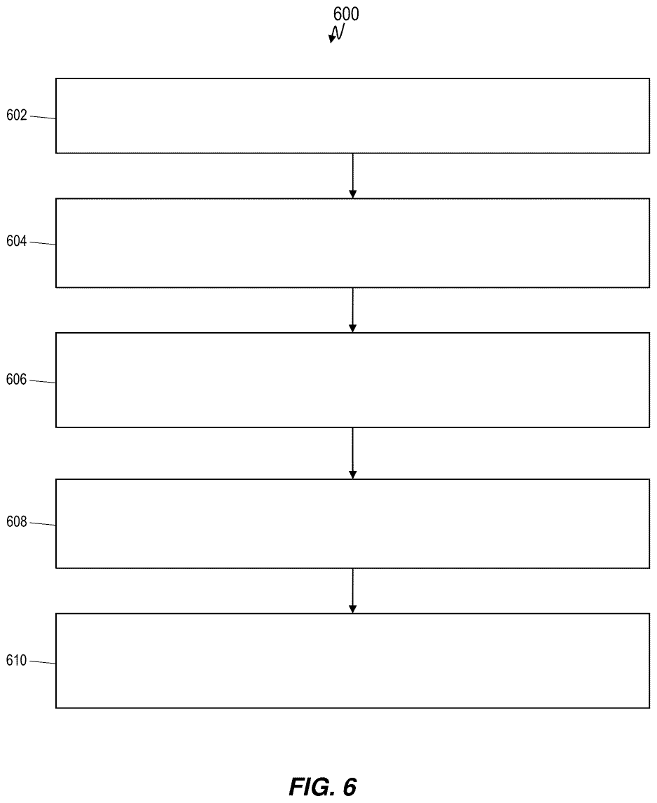

Referring now to FIG. 6, a flowchart 600 for leveraging a membrane-electrode-assembly (MEA) with a trimmed proton-consuming electrode is generally shown according to an embodiment. The flowchart 600 is described in reference to FIGS. 1-5 and may include additional steps not depicted in FIG. 6. Although depicted in a particular order, the blocks depicted in FIG. 6 can be rearranged, subdivided, and/or combined.

At block 602, the method includes forming a proton-generating electrode.

At block 604, the method includes forming a proton-consuming electrode.

At block 606, the method includes forming a membrane positioned between the proton-generating electrode and the proton-consuming electrode.

At block 608, the method includes forming a gas diffusion layer positioned in direct contact with the proton-consuming electrode.

At block 610, the method includes trimming the proton-consuming electrode with respect to a first edge of the proton-generating electrode and with respect to a second edge of the proton-generating electrode. In some embodiments, the first edge is orthogonal to the second edge. In some embodiments, the proton-consuming electrode is trimmed using laser ablation at a focus depth that bypasses the membrane.

In some embodiments, the proton consuming cathode electrode is directly applied to the gas diffusion layer.

In some embodiments, the membrane is applied to the proton-consuming electrode via direct coating or lamination.

In some embodiments, the PEM electrochemical cell is an electrolyzer.

In some embodiments, the method includes forming a porous transport layer in direct contact with the proton-generating electrode.

In some embodiments, the porous transport layer is connected via flow channels to an intake header and an outtake header. The intake header is configured to supply water to the electrolyzer. The outtake header is configured to remove oxygen and water from the electrolyzer.

In some embodiments, the gas diffusion layer includes an outtake header configured to remove hydrogen gas from the electrolyzer.

In some embodiments, the PEM electrochemical cell is a fuel cell.

In some embodiments, the method includes forming a second gas diffusion layer in direct contact with the proton-generating electrode.

In some embodiments, the second gas diffusion layer is connected via flow channels to an intake header and an outtake header. The intake header is configured to supply hydrogen to the fuel cell. The outtake header is configured to remove water from the fuel cell.

In some embodiments, the gas diffusion layer is connected via flow channels to an intake header and an outtake header. The intake header is configured to supply oxygen gas to the fuel cell and the outtake header is configured to remove water from the fuel cell,

FIG. 7A depicts a top-down view of a proton exchange membrane (PEM) electrochemical cell 700 in accordance with one or more embodiments. FIG. 7B depicts a cross-sectional view of the PEM electrochemical cell 700 in accordance with one or more embodiments. PEM electrochemical cell 700 can be configured as a PEM electrolyzer (refer to electrolyzer 118 of FIG. 2A), as a PEM fuel cell (refer to fuel cell 106 of FIG. 2B), or as any other PEM cell, as desired.

As shown in FIG. 7, PEM electrochemical cell 700 includes a plurality of headers 702. It should be understood that the number of headers (intake and/or outtake) shown is merely illustrative and is not meant to be particularly limited. PEM electrochemical cell 700 can include any number of headers 702 and all such configurations are within the contemplated scope of this disclosure. Headers 702 can include intake headers and/or outtake headers in any configuration previously described. The headers 702 are arranged in a frame 704 (also referred to as a subgasket) of the PEM electrochemical cell 700. GDL 302 is arranged in the frame 704 between the headers 702.

As further shown in FIG. 7, PEM electrochemical cell 700 includes an active area 708 which is isolated from GDL 302. Active area 708 can be connected via flow channels (not separately indicated) to the headers 702 and GDL 302. Active area 708 refers to the region of the PEM electrochemical cell 700 where the primary electrochemical reactions occur. In some embodiments, active area 708 is defined by an overlap (refer to FIG. 7B) of the proton exchange membrane (PEM) (e.g., membrane 306), catalyst layers (e.g., electrode 304), and gas diffusion layers (GDLs) (e.g., GDL 302) of the PEM electrochemical cell 700. In some embodiments, active area 708 is defined in part by an opening 710 in the interior of frame 704. In some embodiments, GDL 302, PTL 202, and membrane 306 overlap the frame 704 (subgasket) at the opening 710 (that is, these layers can extend beyond opening 710 of the active area 708 under portions of the frame 704 as shown in FIG. 7B).

While not meant to be particularly limited, frame 704 can include an elastomer film and/or polymer layer that serves to protect edges (not separately indicated) of the PEM from damage and degradation. For example, in some embodiments, frame 704 can include materials such as polyethylene naphthalate (PEN), polyimide (PI), polyethylene terephthalate (PET), or polyphenylene sulfide (PPS) films. Moreover, frame 704 acts as a seal that prevents fluid leakage through components within frame 704 such as to the active area 708. In some embodiments, frame 704 provides mechanical support and/or stabilization for the PEM and helps to control an overall thickness and uniformity of the active area 708.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

Additionally, as used in this disclosure, phrases of the form “at least one of an A, a B, or a C,” “at least one of A, B, and C,” and the like, should be interpreted to select at least one from the group that comprises “A, B, and C. ” Unless explicitly stated otherwise in connection with a particular instance in this disclosure, this manner of phrasing does not mean “at least one of A, at least one of B, and at least one of C. ” As used in this disclosure, the example “at least one of an A, a B, or a C,” would cover any of the following selections: {A}, {B}, {C}, {A, B}, {A, C}, {B, C}, and {A, B, C}.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A proton exchange membrane (PEM) electrochemical cell comprising:
a proton-generating electrode comprising an anode;
a proton-consuming electrode comprising a cathode;
a membrane positioned between the proton-generating electrode and the proton-consuming electrode, the proton-generating electrode, proton-consuming electrode, and membrane collectively defining a membrane-electrode-assembly; and
a gas diffusion layer positioned in direct contact with the proton-consuming electrode;
wherein the proton-consuming electrode is trimmed with respect to a first edge of the proton-generating electrode and with respect to a second edge of the proton-generating electrode, the first edge orthogonal to the second edge, the proton-consuming electrode trimmed using laser ablation at a focus depth that bypasses the membrane.

2. The PEM electrochemical cell of claim 1, wherein the proton consuming cathode electrode is directly applied to the gas diffusion layer.

3. The PEM electrochemical cell of claim 1, wherein the membrane is applied to the proton-consuming electrode via direct coating or lamination.

4. The PEM electrochemical cell of claim 1, wherein the PEM electrochemical cell comprises an electrolyzer.

5. The PEM electrochemical cell of claim 4, further comprising a porous transport layer in direct contact with the proton-generating electrode.

6. The PEM electrochemical cell of claim 1, wherein the PEM electrochemical cell comprises a fuel cell.

7. The PEM electrochemical cell of claim 6, further comprising a second gas diffusion layer in direct contact with the proton-generating electrode.

8. A vehicle comprising:
an electric motor;
a battery electrically coupled to the electric motor; and
a proton exchange membrane (PEM) electrochemical cell electrically coupled to at least one of the electric motor or the battery, the PEM electrochemical cell comprising:
a proton-generating electrode comprising an anode of the PEM electrochemical cell;
a proton-consuming electrode comprising a cathode of the PEM electrochemical cell;
a membrane positioned between the proton-generating electrode and the proton-consuming electrode, the proton-generating electrode, proton-consuming electrode, and membrane collectively defining a membrane-electrode-assembly; and
a gas diffusion layer positioned in direct contact with the proton-consuming electrode;
wherein the proton-consuming electrode is trimmed with respect to a first edge of the proton-generating electrode and with respect to a second edge of the proton-generating electrode, the first edge orthogonal to the second edge, the proton-consuming electrode trimmed using laser ablation at a focus depth that bypasses the membrane.

9. The vehicle of claim 8, wherein the proton consuming cathode electrode is directly applied to the gas diffusion layer.

10. The vehicle of claim 8, wherein the membrane is applied to the proton-consuming electrode via direct coating or lamination.

11. The vehicle of claim 8, wherein the PEM electrochemical cell comprises an electrolyzer.

12. The vehicle of claim 11, further comprising a porous transport layer in direct contact with the proton-generating electrode.

13. The vehicle of claim 8, wherein the PEM electrochemical cell comprises a fuel cell.

14. The vehicle of claim 13, further comprising a second gas diffusion layer in direct contact with the proton-generating electrode.

15. A method for forming a proton exchange membrane (PEM) electrochemical cell, the method comprising:
forming a proton-generating electrode comprising an anode;
forming a proton-consuming electrode comprising a cathode;
forming a membrane positioned between the proton-generating electrode and the proton-consuming electrode, the proton-generating electrode, proton-consuming electrode, and membrane collectively defining a membrane-electrode-assembly;
forming a gas diffusion layer positioned in direct contact with the proton-consuming electrode; and
trimming the proton-consuming electrode with respect to a first edge of the proton-generating electrode and with respect to a second edge of the proton-generating electrode, the first edge orthogonal to the second edge, the proton-consuming electrode trimmed using laser ablation at a focus depth that bypasses the membrane.

16. The method of claim 15, wherein the proton consuming cathode electrode is directly applied to the gas diffusion layer.

17. The method of claim 15, wherein the membrane is applied to the proton-consuming electrode via direct coating or lamination.

18. The method of claim 15, wherein the PEM electrochemical cell comprises an electrolyzer.

19. The method of claim 16, further comprising forming a porous transport layer in direct contact with the proton-generating electrode.

20. The method of claim 15, wherein the PEM electrochemical cell comprises a fuel cell, the method further comprising forming a second gas diffusion layer in direct contact with the proton-generating electrode.
